(19) United States
(12) Patent Application Publication
(10) Pub. No.: US 2026/0300101 A1
(43) Pub. Date: Oct. 1, 2026

(54) Multi-Tenant Database Backup and Recovery

(71) Applicant: Oracle International Corporation, Redwood Shores, CA (US)

(72) Inventors: Dmitry SMIRNOV, Munich (DE); Mark ROSSI, Walnut Creek, CA (US); Prasad BODLA, Foster City, CA (US); John Angelo CAFOLLA, Mountain View, CA (US); Thomas Joseph POULSEN, Palo Alto, CA (US)

(21) Appl. No.: 19/093,329

(22) Filed: Mar. 28, 2025

(51) Int. Cl. G06F 11/14

(52) U.S. Cl. CPC G06F 11/1451; G06F 11/1435; G06F 11/1464

(57) ABSTRACT

Embodiments back up application data for an application in a database for a tenant in a multi-tenant cloud based system. Embodiments, using a REST API, extract metadata of the database that corresponds to the tenant. Based on the metadata, embodiments identify one or more workspaces of the database that correspond to the tenant. For each of the workspaces, embodiments call REST API operations to collect the metadata corresponding to the workspaces and collect table data corresponding to the workspaces. Embodiments upload the collected metadata and table data to a backup archive.

### FIELD

One embodiment is directed generally to a computer system, and in particular to a multi-tenant computer system.

### BACKGROUND INFORMATION

A database backup is a copy of a database that is created to ensure data can be restored in case of data loss, corruption, hardware failure, or cyberattacks. It allows organizations to recover critical information and resume operations without significant downtime.

Different types of database backups include a full backup, which is a complete copy of the entire database, an incremental backup, which backs up only the changes made since the last backup, a differential backup, which backs up changes made since the last full backup, a logical backup, which exports database objects such as tables, schemas, and records in a readable format (e.g., SQL scripts), and a physical backup, which copies actual database files, including indexes and logs.

Known database backup methods include on-site backup, which is stored on local storage or servers, off-site backup, which is stored at a remote location or data center, cloud backup, which is stored on cloud-based storage solutions, and automated backup, which are scheduled backups using scripts or software.

### SUMMARY

Embodiments back up application data for an application in a database for a tenant in a multi-tenant cloud based system. Embodiments, using a REST API, extract metadata of the database that corresponds to the tenant. Based on the metadata, embodiments identify one or more workspaces of the database that correspond to the tenant. For each of the workspaces, embodiments call REST API operations to collect the metadata corresponding to the workspaces and collect table data corresponding to the workspaces. Embodiments upload the collected metadata and table data to a backup archive.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an example of a system that includes a backup system in accordance to embodiments.

FIG. 2 is a block diagram of the backup system of FIG. 1 in the form of a computer server/system in accordance to an embodiment of the present invention.

FIG. 3 is a block/flow diagram of the functionality of the backup system and various other elements of the system of FIG. 1 of when a backup is performed in accordance to embodiments.

FIG. 4 illustrates the dataset synchronization process in accordance to embodiments.

FIG. 5 illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, in accordance with an embodiment.

### DETAILED DESCRIPTION

Embodiments provide a framework for backup functionality of a shared database to a tenant in a multi-tenant system. Embodiments provide automatic backups of data, including application artifacts, by using a REST API to extract the backup data.

In general, in a multi-tenant system (e.g., a cloud system), a database is shared among all of the tenants/clients for a particular application. Each tenant is isolated from each other for security purposes and accesses the database through the same database layer. However, due to the isolation, any backup database facility associated with the database (i.e., the system, tools, or features within a database management system (“DBMS”) that allows a user to create and manage copies/backups of the database) is not available to each tenant for backup and recovery purposes. Example backup database facilities include “Recovery Manager” and “Data Pump” from Oracle Corp.”, and user-managed backups such as the UNIX dd or tar commands and similar backup facilities. Known backup solutions for a tenant include using a Structured Query Language (“SQL”) console and an export facility, but this is not useful for automated backup. Other known solutions use an archiving facility to restore data to a previous checkpoint in time for a database instance, but it is difficult to get the preferred state of the tenant as the backup is limited to the available checkpoint times.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

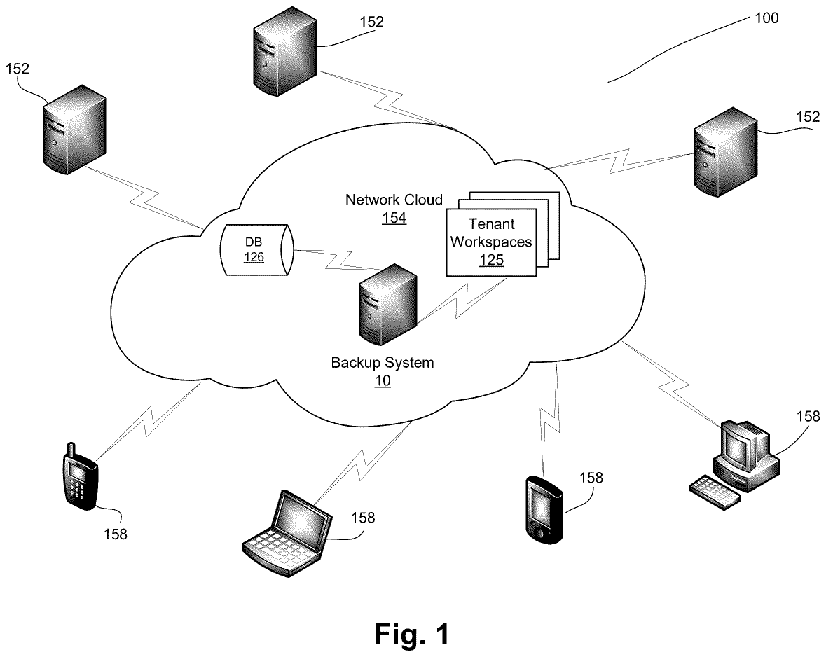

FIG. 1 illustrates an example of a system 100 that includes a backup system 10 in accordance to embodiments. Backup system 10 may be implemented within a computing environment that includes a communication network/cloud 154. Network 154 may be a private network that can communicate with a public network (e.g., the Internet) to access additional services 152 provided by a cloud services provider. Examples of communication networks include a mobile network, a wireless network, a cellular network, a local area network (“LAN”), a wide area network (“WAN”), other wireless communication networks, or combinations of these and other networks. Backup system 10 may be administered by a service provider, such as via the Oracle Cloud Infrastructure (“OCI”) from Oracle Corp.

Tenants of the cloud services provider can be companies or any type of organization or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 158, which can be any type of device that can access network 154 and can obtain the benefits of the functionality of backup system 10 for backing up data for tenants in a cloud system. As disclosed herein, a “client” (also disclosed as a “client system” or a “client device”) may be a device or an application executing on a device. System 100 includes a number of different types of client devices 158 that each is able to communicate with network 154.

Executing on cloud 154 (or otherwise in communication with backup system 10) is at least one database (“DB”) 126. Database 126 stores data used by tenants/clients of cloud 154 on a shared basis. Database 126 may be any type of database, including relational, object-oriented, hierarchical, graph, NoSQL, cloud, centralized, or a distributed database. In one embodiment, database 126 is implemented by the “Oracle Cloud Database” and is a relational database management system (“RDBMS”).

Further executing on cloud 154 (or otherwise in communication with backup system 10) are tenant workspaces 125. Each tenant of cloud 154 has one or more corresponding tenant workspaces 125. A tenant workspace 125, in general, is a dedicated, isolated area within a cloud-based platform where a specific organization (i.e., a “tenant”) can store and manage their data, applications, and user access, essentially acting as a separate working environment within a shared infrastructure. Tenant workspace 125 allows different organizations to operate independently while sharing the same platform, with distinct data separation and access controls. Each tenant, via tenant workspace 125, shares an isolated portion of database 126 for storing and retrieving data.

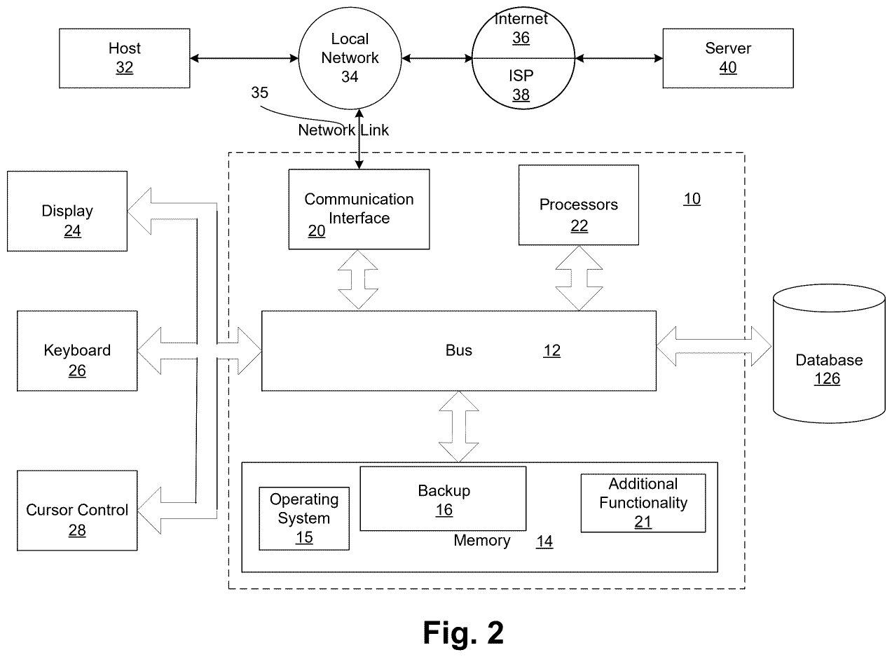

FIG. 2 is a block diagram of backup system 10 of FIG. 1 in the form of a computer server/system 10 in accordance to an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a backup module 16 that provides database backup and restore functionality on a per workspace basis for data on shared database 126, and all other functionality disclosed herein. System 10 can be part of a larger system. Therefore, system 10 can include one or more additional functional modules 21, such as any application being executed on a workspace 125 that accesses data from database 126.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 10, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

In general, there are no known solutions for backing up data from within an isolated workspace in a multi-tenant environment. For example, in one embodiment, a user may have many applications running in an application development platform such as “Oracle APEX” (i.e., apex.oraclecorp.com). Oracle APEX is a low-code application development platform from Oracle Corp. that allows users to build and deploy web, mobile, and desktop applications with a visual, web-based interface, utilizing primarily SQL and PL/SQL code, without requiring extensive programming expertise. Oracle APEX enables rapid development of applications by using drag-and-drop features and wizards within the Oracle database itself (e.g., database 126). In this example, the multiple applications are running under a single workspace 125, using many database transaction tables (e.g., 70 transaction tables). However, there is no known solutions to provide an automated regular backup data (i.e., a complete schema) in this example. Specifically, in this example, with known solutions, is not possible for the tenants to leverage any RDBMS 126 backup/restore mechanisms, such as export/import, datapump, SQL*Loader, etc.

In multi-tenant development environments with isolated workspaces, such as Oracle APEX, the database/operating system level backup/restore mechanisms can not be exposed to the tenants, due to the need to maintain the required tenant isolation level, tenant security restrictions or other multi-tenancy related considerations. In contrast to known solutions, embodiments provide a backup/restore mechanism to any number of tenants, workspaces or cloud-based applications in a multi-tenant environment with the isolated workspaces. Embodiments implement, on a regular basis, automated backups of application data to provide a recovery option in case of an accidental data loss or a catastrophic failure.

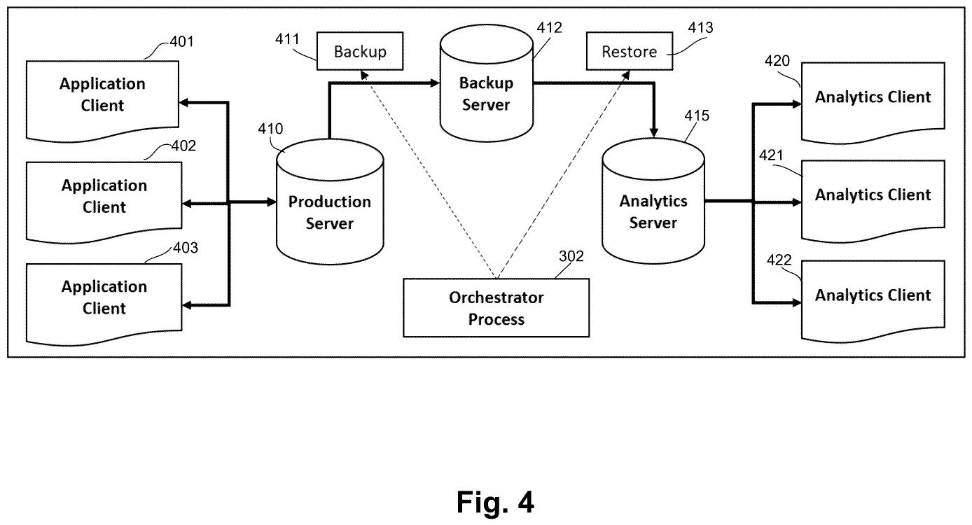

Further, embodiments implement, on a regular basis, the synchronization of external datasets. An “external dataset” represents application data which has been exported, transformed and loaded into the external data warehouse platform to generate the application analytics data and to provide the analytics-based reporting capabilities. An external data warehouse (e.g., analytics server 415 of FIG. 4, disclosed below) refers to a data warehouse that incorporates data from sources outside of an organization's internal systems, enabling broader analysis and decision-making. This contrasts with internal data warehouses, which focus solely on an organization's own data. Examples of the external data warehouse platforms, running outside of the multi-tenant development environment, which can be used for analytics-based reporting, include Oracle “Analytics Cloud”, “Analytics Server” and “Data Warehouse” from Oracle Corp., Amazon Redshift, Azure Synapse Analytics, etc. In general, there are no known solutions for exporting application data from an isolated workspace in a multi-tenant environment to an external data warehouse platform. Usage of the Extract, Transform, Load (“ETL”) tools is generally not possible due to the restrictions of an isolated workspace in a multi-tenant environment.

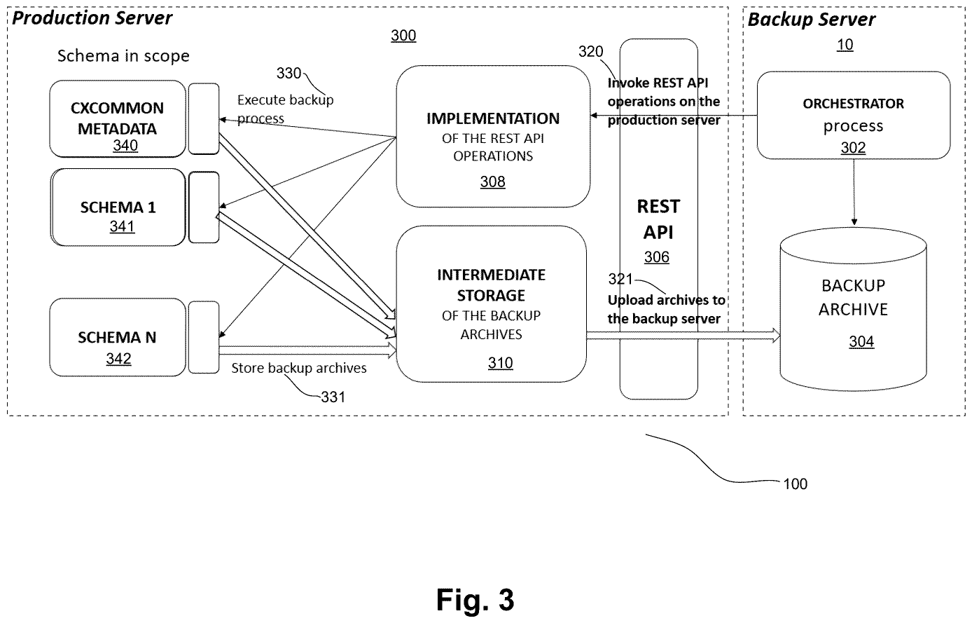

FIG. 3 is a block/flow diagram of the functionality of backup system 10 and various other elements of system 100 of FIG. 1 of when a backup is performed in accordance to embodiments. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

System 100 includes a backup server/system 10, and a production server 300 which executes the application to be backed up, including tenant workspaces 125 and database 126. Production server 300 is a server hosting the applications running in production mode. Applications in production mode are used by the end-users or customers in a live environment. Production server 300 hosts the final, stable version of the applications, deployed to the production server after development and testing. The functionality of production server 300 is accessed by backup server 10 via a Representational State Transfer application program interface (“REST API”) 306. REST API 306 includes a set of rules and conventions for building and interacting with web services. It allows different software applications to communicate with each other over the Internet using standard Hypertext Transfer Protocol (“HTTP”) methods. REST API 306 securely exposes the backup and restore operations to backup server 10.

Production server 300 includes database data to be backed up, which include metadata 340, and schemas 341, 342, . . . , where each tenant in a workspace is assigned to an individual schema or multiple schemas that need to be backed up. An APEX schema is a collection of APEX metadata (applications, pages, security, etc.) and database objects (tables, views, indexes, sequences, stored procedures, etc.) owned by an APEX user/tenant. Each APEX user can have one or more schemas assigned in a workspace. CXCOMMON is a name of an APEX schema where the backup process metadata is stored. In embodiments where the application is APEX, “CXCOMMON” 340 is an apex workspace which contains the backup framework metadata and hosts the SQL and PLSQL procedures performing the backup/restore operations. In non APEX specific embodiments, corresponding tenant schemas as well as common schemas with backup process metadata can be used.

Backup server 10 includes a backup archive 304 which is an external secure data store that holds the backed-up content. In one embodiment, backup archive is implemented as an Oracle virtual machine (“VM”) running in the Oracle Cloud Infrastructure (“OCI”). Other embodiments can have a backup archive implemented as a physical or a virtual host running in a datacenter, or in a different cloud infrastructure such as Salesforce Cloud, Microsoft Azure, etc.

Backup server 10 further includes an orchestrator 302 which implements an orchestrating process that performs the backups on a predefined schedule (e.g., hourly, daily, etc.). In one embodiment, orchestrator 302 is implemented as a shell script that is scheduled on the Oracle VM.

At 320, a scheduler (e.g., a “cron” command like utility) initiates the orchestrator script as a background process on the VM. Orchestrator 302 uses REST API operation 306 to extract the metadata to identify the backup scope, which is a list of workspaces to be included into the backup process. An example REST operation to identify the workspaces is as follows:

GET operation: SCOPE

### Parameters:

None

### Returns:

JSON document with a list of workspaces/schemas included into the backup scope.

### Implementation:

Retrieves a list of workspaces/schemas defined in the CXCOMMON metadata.

At 330, for each workspace identified at 320, orchestrator 302 asynchronously calls the REST API operations to perform the following backup processes in one embodiment:
1. Collect the workspace backup process metadata 340 in Extensible Markup Language (“XML”) format.
2. Collect the workspace table data in XML format.
3. Create and store a zipped archive of the data collected in 1 and 2.
   An example of a REST operation to execute 1-3 above is as follows:
   POST operation: EXECUTE

### Parameters:

WORKSPACE_NAME (STRING)
SCHEMA_NAME (STRING)
PATTERN (STRING)

### Returns:

TRUE if submission was successful, FALSE otherwise.

### Implementation:

Retrieves the latest version of the backup implementation code from the CXCOMMON metadata repository.
Deploys the implementation code, retrieved in the previous step, into the designated workspace/schema and compiles it.
Submits an asynchronous background process to execute the code, deployed and compiled in the previous step, to perform the backup of:
   The designated workspace (WORKSPACE_NAME) apex metadata.
   The designated schema (SCHEMA_NAME) database object metadata.
   Table contents for the database tables, where table names match PATTERN.

For each zipped archive created in (3) above, orchestrator 302 performs a secure upload to backup archive 304 and encrypts the archived files. This includes, at 331, the backup archives being stored in intermediate storage 310, and at 321 uploading the files in backup archive 304. Intermediate storage 310 is used to separate the zipped archive creation process from the upload process. This approach allows orchestrator 302 to start working on the creation of the next zipped archive in parallel with uploading the previously created zipped archive from intermediate storage 310 to the backup archive 304. Intermediate storage 310 is purged after the upload process is complete. In one embodiment, intermediate storage 310 is implemented as a database table with a Binary Large Object (“BLOB”) attribute, which stores the contents of a zipped archive. In one embodiment, backup archive 304 is implemented as an Oracle VM directory, where the encrypted archive files are stored. After the upload process is complete, the data in the backup archive is available to the tenant. The process of exporting the archived data from the backup archive 304 to the external data warehouse (i.e., analytics server 415) is a separate process, which can be executed independently. An example of a REST operation to upload the backup files at 306 is as follows:

GET operation: IN-PROGRESS

### Parameters:

None

### Returns:

Null if the asynchronous backup process is still in progress.
JSON document with the ID of the datafile ready for upload.

### Implementation:

Checks if the asynchronous backup process is still running in the background.
Generates the ID of the datafile containing the backup archive.
   GET operation: ARCHIVE

### Parameters:

ID of the datafile containing the backup archive.

### Returns:

A binary stream containing the archived content.

### Implementation:

Creates a binary stream which allows to download the archived content.

For each designated dataset, orchestrator 302 then performs a restore (i.e., synchronization) into the external system (e.g., external data warehouse or data analytics server 415). In embodiments, an external dataset represents application data which has been exported, transformed and loaded into the external data warehouse platform (i.e., analytics server 415) to generate the application analytics data and to provide the analytics-based reporting capabilities to the analytics clients 420-422. FIG. 4 illustrates the dataset synchronization process in accordance to embodiments. The multi-tenant application to be backed up includes multiple clients 401-403 that store and retrieve data from cloud based production server/database 410. Production server 410 is a closed system because each client 401-403 has access to only their own corresponding workspaces, but do not have access to the entire database hosted by product server 410. Orchestrator process 302, as disclosed above, executes backup functionality 411 using the REST API, so that the data is stored in backup server 412. Orchestrator process 302, as disclosed above, also executes restore functionality 413, where the backup data is stored in an analytics server 415. Analytics server 415, in contrast to production server 410, is an open system so that all of the stored data, as opposed to data stored in the client's respective workspace, is available to each of analytics client 420-422.

### Data Analytics Environment

Embodiments of the invention are implemented as part of a cloud based data analytics environment, via for example the use of analytics server 415. In general, data analytics enables the computer-based examination or analysis of large amounts of data, in order to derive conclusions or other information from that data; while business intelligence tools provide an organization's business users with information describing their enterprise data in a format that enables those business users to make strategic business decisions.

Examples of data analytics environments and business intelligence tools/servers include Oracle Business Intelligence Server (“OBIS”), Oracle Analytics Cloud (“OAC”), and Fusion Analytics Warehouse (“FAW”), which support features such as data mining or analytics, and analytic applications.

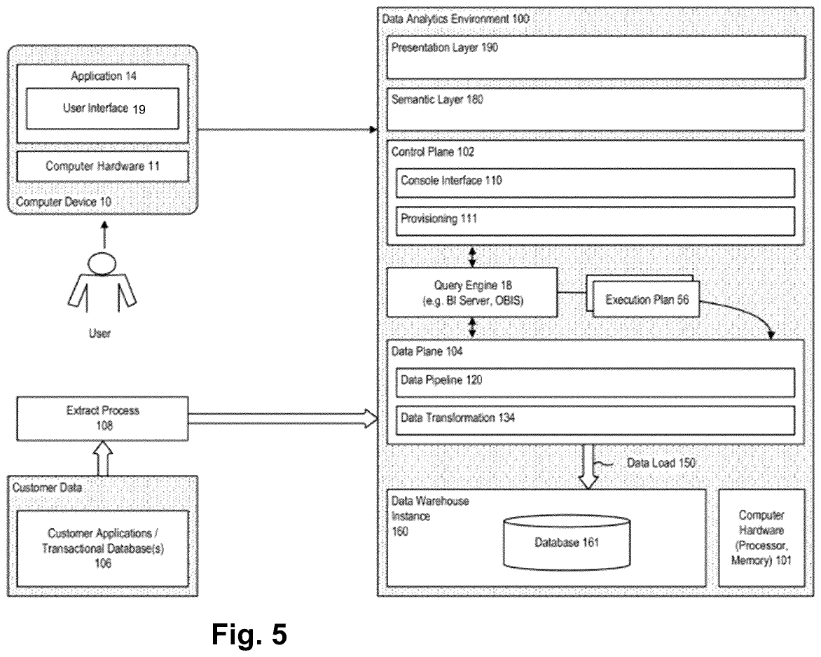

FIG. 5 illustrates an example data analytics environment, in accordance with an embodiment. The example embodiment illustrated in FIG. 5 is provided for purposes of illustrating an example of a data analytics environment in association with which various embodiments described herein can be used. In accordance with other embodiments and examples, the approach described herein can be used with other types of data analytics, database, or data warehouse environments. The components and processes illustrated in FIG. 5, and as further described herein with regard to various other embodiments, can be provided as software or program code executable by, for example, a cloud computing system, or other suitably-programmed computer system.

As illustrated in FIG. 5, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse, data warehouse instance 160, database 161, or other type of data source.

In accordance with an embodiment, the control plane operates to provide control for cloud or other software products offered within the context of a SaaS or cloud environment, such as, for example, an Oracle Analytics Cloud environment, or other type of cloud environment. For example, in accordance with an embodiment, the control plane can include a console interface 110 that enables access by a customer (tenant) and/or a cloud environment having a provisioning component 111.

In accordance with an embodiment, the console interface can enable access by a customer (tenant) operating a graphical user interface (“GUI”) and/or a command-line interface (“CLI”) or other interface; and/or can include interfaces for use by providers of the SaaS or cloud environment and its customers (tenants). For example, in accordance with an embodiment, the console interface can provide interfaces that allow customers to provision services for use within their SaaS environment, and to configure those services that have been provisioned.

In accordance with an embodiment, a customer (tenant) can request the provisioning of a customer schema within the data warehouse. The customer can also supply, via the console interface, a number of attributes associated with the data warehouse instance, including required attributes (e.g., login credentials), and optional attributes (e.g., size, or speed). The provisioning component can then provision the requested data warehouse instance, including a customer schema of the data warehouse; and populate the data warehouse instance with the appropriate information supplied by the customer.

In accordance with an embodiment, the provisioning component can also be used to update or edit a data warehouse instance, and/or an extract, transform, and load (“ETL”) process that operates at the data plane, for example, by altering or updating a requested frequency of ETL process runs, for a particular customer (tenant).

In accordance with an embodiment, the data plane can include a data pipeline or process layer 120 and a data transformation layer 134, that together process operational or transactional data from an organization's enterprise software application or data environment, such as, for example, business productivity software applications provisioned in a customer's (tenant's) SaaS environment. The data pipeline or process can include various functionality that extracts transactional data from business applications and databases that are provisioned in the SaaS environment, and then load a transformed data into the data warehouse.

In accordance with an embodiment, the data transformation layer can include a data model, such as, for example, a knowledge model (“KM”), or other type of data model, that the system uses to transform the transactional data received from business applications and corresponding transactional databases provisioned in the SaaS environment, into a model format understood by the data analytics environment. The model format can be provided in any data format suited for storage in a data warehouse. In accordance with an embodiment, the data plane can also include a data and configuration user interface, and mapping and configuration database.

In accordance with an embodiment, the data plane is responsible for performing ETL operations, including extracting transactional data from an organization's enterprise software application or data environment, such as, for example, business productivity software applications and corresponding transactional databases offered in a SaaS environment, transforming the extracted data into a model format, and loading the transformed data into a customer schema of the data warehouse.

For example, in accordance with an embodiment, each customer (tenant) of the environment can be associated with their own customer tenancy within the data warehouse, that is associated with their own customer schema; and can be additionally provided with read-only access to the data analytics schema, which can be updated by a data pipeline or process, for example, an ETL process, on a periodic or other basis.

In accordance with an embodiment, a data pipeline or process can be scheduled to execute at intervals (e.g., hourly/daily/weekly) to extract transactional data from an enterprise software application or data environment, such as, for example, business productivity software applications and corresponding transactional databases 106 that are provisioned in the SaaS environment.

In accordance with an embodiment, an extract process 108 can extract the transactional data, whereupon extraction of the data pipeline or process can insert extracted data into a data staging area, which can act as a temporary staging area for the extracted data. The data quality component and data protection component can be used to ensure the integrity of the extracted data. For example, in accordance with an embodiment, the data quality component can perform validations on the extracted data while the data is temporarily held in the data staging area.

In accordance with an embodiment, when the extract process has completed its extraction, the data transformation layer can be used to begin the transform process, to transform the extracted data into a model format to be loaded into the customer schema of the data warehouse.

In accordance with an embodiment, the data pipeline or process can operate in combination with the data transformation layer to transform data into the model format. The mapping and configuration database can store metadata and data mappings that define the data model used by data transformation. The data and configuration user interface (“UI”) can facilitate access and changes to the mapping and configuration database.

In accordance with an embodiment, the data transformation layer can transform extracted data into a format suitable for loading into a customer schema of data warehouse, for example according to the data model. During the transformation, the data transformation can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150 to load the transformed data into the customer schema of the data warehouse instance. Subsequent to the loading of the transformed data into customer schema, the transformed data can be analyzed and used in a variety of additional business intelligence processes.

Different customers of a data analytics environment may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a semantic model can be defined, for example, in an Oracle environment, as a BI Repository (“RPD”) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, a customer may perform modifications to their data source model, to support their particular requirements, for example by adding custom facts or dimensions associated with the data stored in their data warehouse instance; and the system can extend the semantic model accordingly.

In accordance with an embodiment, the presentation layer can enable access to the data content using, for example, a software analytic application, user interface, dashboard, key performance indicators (“KPI”'s); or other type of report or interface as may be provided by products such as, for example, Oracle Analytics Cloud, or Oracle Analytics for Applications.

In accordance with an embodiment, a query engine 18 (e.g., OBIS) operates in the manner of a federated query engine to serve analytical queries within, e.g., an Oracle Analytics Cloud environment, via SQL, pushes down operations to supported databases, and translates business user queries into appropriate database-specific query languages (e.g., Oracle SQL, SQL Server SQL, DB2 SQL, or Essbase MDX). The query engine (e.g., OBIS) also supports internal execution of SQL operators that cannot be pushed down to the databases.

In accordance with an embodiment, a user/developer can interact with a client computer device 10 that includes a computer hardware 11 (e.g., processor, storage, memory), user interface 19, and application 14. A query engine or business intelligence server such as OBIS generally operates to process inbound, e.g., SQL, requests against a database model, build and execute one or more physical database queries, process the data appropriately, and then return the data in response to the request.

To accomplish this, in accordance with an embodiment, the query engine or business intelligence server can include various components or features, such as a logical or business model or metadata that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, a query engine or business intelligence server may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine (e.g., OBIS) can process queries against a database according to a query execution plan 56, that can include various child (leaf) nodes, generally referred to herein in various embodiments as RqLists, and produces one or more diagnostic log entries. Within a query execution plan, each execution plan component (RqList) represents a block of query in the query execution plan, and generally translates to a SELECT statement. An RqList may have nested child RqLists, similar to how a SELECT statement can select from nested SELECT statements.

In accordance with an embodiment, during operation the query engine or business intelligence server can create a query execution plan which can then be further optimized, for example to perform aggregations of data necessary to respond to a request. Data can be combined together and further calculations applied, before the results are returned to the calling application, for example via the ODBC interface.

In accordance with an embodiment, a complex, multi-pass request that requires multiple data sources may require the query engine or business intelligence server to break the query down, determine which sources, multi-pass calculations, and aggregates can be used, and generate the logical query execution plan spanning multiple databases and physical SQL statements, wherein the results can then be passed back, and further joined or aggregated by the query engine or business intelligence server.

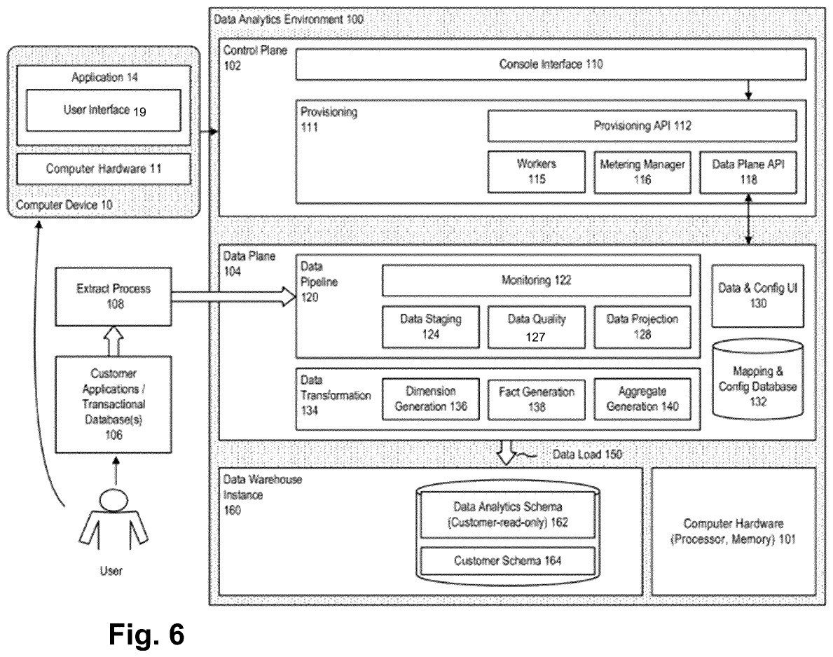

FIG. 6 further illustrates an example data analytics environment, in accordance with an embodiment. As illustrated in FIG. 6, in accordance with an embodiment, the provisioning component can also comprise a provisioning application programming interface (“API”) 112, a number of workers 115, a metering manager 116, and a data plane API 118, as further described below. The console interface can communicate, for example, by making API calls, with the provisioning API when commands, instructions, or other inputs are received at the console interface to provision services within the SaaS environment, or to make configuration changes to provisioned services.

In accordance with an embodiment, the data plane API can communicate with the data plane. For example, in accordance with an embodiment, provisioning and configuration changes directed to services provided by the data plane can be communicated to the data plane via the data plane API.

In accordance with an embodiment, the metering manager can include various functionality that meters services and usage of services provisioned through control plane. For example, in accordance with an embodiment, the metering manager can record a usage over time of processors provisioned via the control plane, for particular customers (tenants), for billing purposes. Likewise, the metering manager can record an amount of storage space of data warehouse partitioned for use by a customer of the SaaS environment, for billing purposes.

In accordance with an embodiment, the data pipeline or process, provided by the data plane, can including a monitoring component 122, a data staging component 124, a data quality component 127, and a data projection component 128, as further described below.

In accordance with an embodiment, the data transformation layer can include a dimension generation component 136, fact generation component 138, and aggregate generation component 140, as further described below. The data plane can also include a data and configuration user interface 130, and mapping and configuration database 132.

In accordance with an embodiment, the data warehouse can include a default data analytics schema (referred to herein in accordance with some embodiments as an analytic warehouse schema) 162 and, for each customer (tenant) of the system, a customer schema 164.

In accordance with an embodiment, to support multiple tenants, the system can enable the use of multiple data warehouses or data warehouse instances. For example, in accordance with an embodiment, a first warehouse customer tenancy for a first tenant can comprise a first database instance, a first staging area, and a first data warehouse instance of a plurality of data warehouses or data warehouse instances; while a second customer tenancy for a second tenant can comprise a second database instance, a second staging area, and a second data warehouse instance of the plurality of data warehouses or data warehouse instances.

In accordance with an embodiment, based on the data model defined in the mapping and configuration database, the monitoring component can determine dependencies of several different data sets to be transformed. Based on the determined dependencies, the monitoring component can determine which of several different data sets should be transformed to the model format first.

For example, in accordance with an embodiment, if a first model dataset incudes no dependencies on any other model data set; and a second model data set includes dependencies to the first model data set; then the monitoring component can determine to transform the first data set before the second data set, to accommodate the second data set's dependencies on the first data set.

For example, in accordance with an embodiment, dimensions can include categories of data such as, for example, “name,” “address,” or “age”. Fact generation includes the generation of values that data can take, or “measures.” Facts can be associated with appropriate dimensions in the data warehouse instance. Aggregate generation includes creation of data mappings which compute aggregations of the transformed data to existing data in the customer schema of data warehouse instance.

In accordance with an embodiment, once any transformations are in place (as defined by the data model), the data pipeline or process can read the source data, apply the transformation, and then push the data to the data warehouse instance.

In accordance with an embodiment, data transformations can be expressed in rules, and once the transformations take place, values can be held intermediately at the staging area, where the data quality component and data projection components can verify and check the integrity of the transformed data, prior to the data being uploaded to the customer schema at the data warehouse instance. Monitoring can be provided as the extract, transform, load process runs, for example, at a number of compute instances or virtual machines. Dependencies can also be maintained during the extract, transform, load process, and the data pipeline or process can attend to such ordering decisions.

In accordance with an embodiment, after transformation of the extracted data, the data pipeline or process can execute a warehouse load procedure, to load the transformed data into the customer schema of the data warehouse instance. Subsequent to the loading of the transformed data into customer schema, the transformed data can be analyzed and used in a variety of additional business intelligence processes.

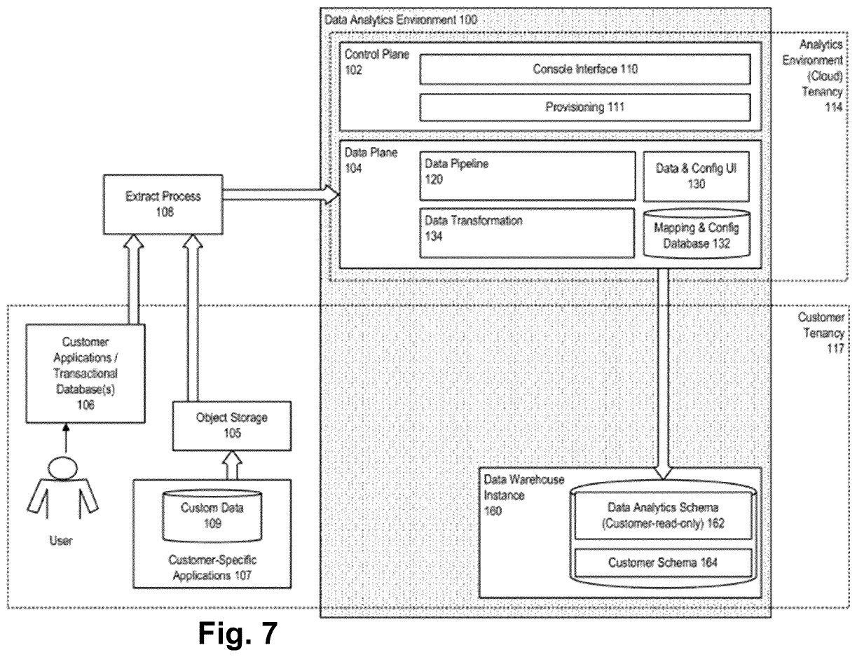

FIG. 7 further illustrates an example data analytics environment, in accordance with an embodiment. As illustrated in FIG. 7, in accordance with an embodiment, data can be sourced, e.g., from a customer's (tenant's) enterprise software application or data environment (106), using the data pipeline process; or as custom data 109 sourced from one or more customer-specific applications 107; and loaded to a data warehouse instance, including in some examples the use of an object storage 105 for storage of the data.

In accordance with embodiments of analytics environments such as, for example, Oracle Analytics Cloud (“OAC”), a user can create a data set that uses tables from different connections and schemas. The system uses the relationships defined between these tables to create relationships or joins in the data set.

In accordance with an embodiment, for each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that is readily modifiable by the customer, and which allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse (e.g., ADW) can include a data analytics schema and, for each customer/tenant, a customer schema sourced from their enterprise software application or data environment. The data provisioned in a data warehouse tenancy (e.g., an ADW cloud tenancy) is accessible only to that tenant; while at the same time allowing access to various, e.g., ETL-related or other features of the shared environment.

In accordance with an embodiment, to support multiple customers/tenants, the system enables the use of multiple data warehouse instances; wherein for example, a first customer tenancy can comprise a first database instance, a first staging area, and a first data warehouse instance; and a second customer tenancy can comprise a second database instance, a second staging area, and a second data warehouse instance.

In accordance with an embodiment, for a particular customer/tenant, upon extraction of their data, the data pipeline or process can insert the extracted data into a data staging area for the tenant, which can act as a temporary staging area for the extracted data. A data quality component and data protection component can be used to ensure the integrity of the extracted data; for example by performing validations on the extracted data while the data is temporarily held in the data staging area. When the extract process has completed its extraction, the data transformation layer can be used to begin the transformation process, to transform the extracted data into a model format to be loaded into the customer schema of the data warehouse.

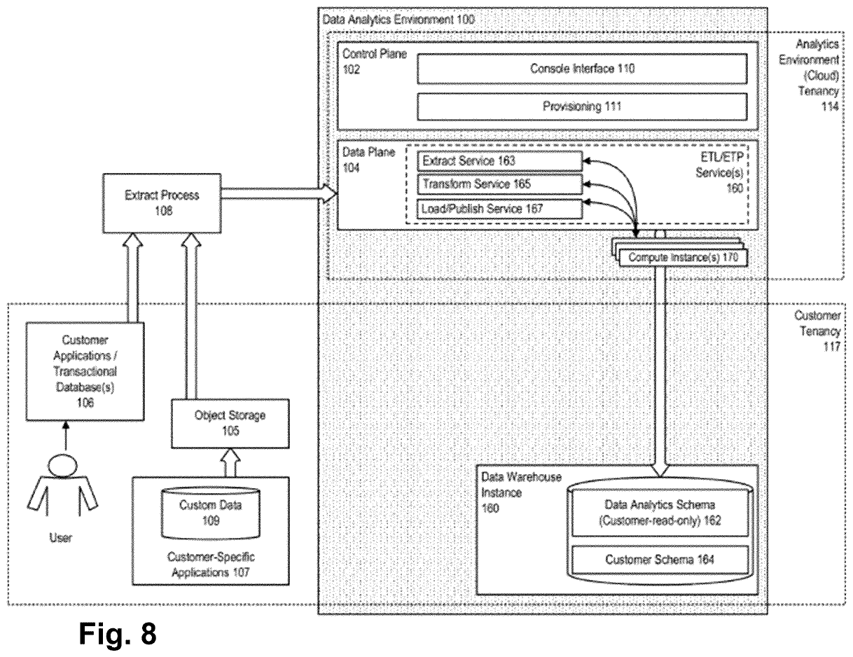

FIG. 8 further illustrates an example data analytics environment, in accordance with an embodiment. As illustrated in FIG. 8, in accordance with an embodiment, the process of extracting data, e.g., from a customer's (tenant's) enterprise software application or data environment, using the data pipeline process as described above; or as custom data sourced from one or more customer-specific applications; and loading the data to a data warehouse instance, or refreshing the data in a data warehouse, generally involves three broad stages, performed by an ETP service 160 or process, including one or more extraction service 163; transformation service 165; and load/publish service 167, executed by one or more compute instance(s) 170.

For example, in accordance with an embodiment, a list of view objects for extractions can be submitted, for example, to an Oracle BI Cloud Connector (“BICC”) component via a ReST call. The extracted files can be uploaded to an object storage component, such as, for example, an Oracle Storage Service (“OSS”) component, for storage of the data. The transformation process takes the data files from object storage component (e.g., OSS), and applies a business logic while loading them to a target data warehouse, e.g., an ADW database, which is internal to the data pipeline or process, and is not exposed to the customer (tenant). A load/publish service or process takes the data from the, e.g., ADW database or warehouse, and publishes it to a data warehouse instance that is accessible to the customer (tenant).

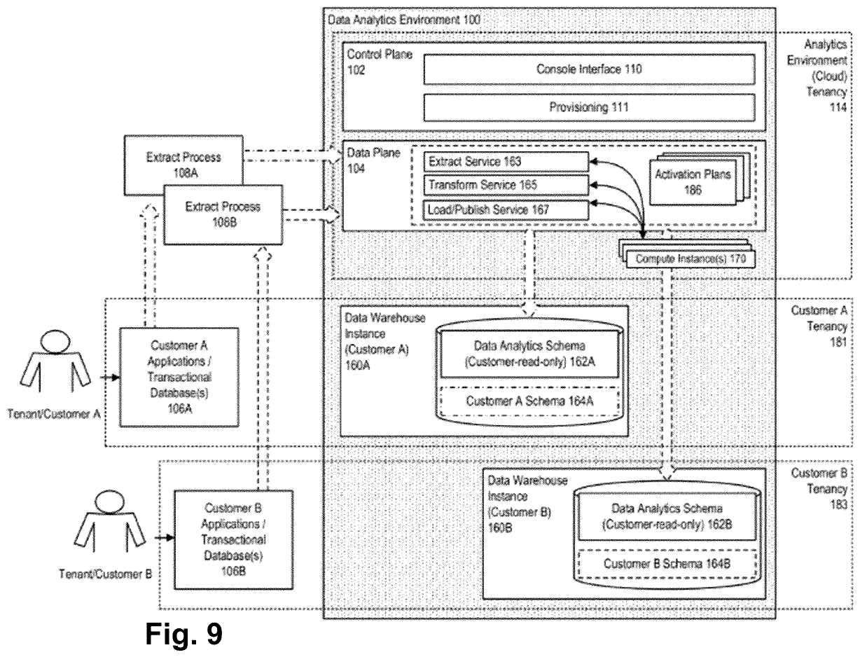

FIG. 9 further illustrates an example data analytics environment, in accordance with an embodiment. As illustrated in FIG. 9, which illustrates the operation of the system with a plurality of tenants (customers) in accordance with an embodiment, data can be sourced, e.g., from each of a plurality of customer's (tenant's) enterprise software application or data environment, using the data pipeline process as described above; and loaded to a data warehouse instance.

In accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case.

In accordance with an embodiment, for each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that is readily modifiable by the customer, and which allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to begin the transformation process, to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs.

For example, in accordance with an embodiment, an activation plan can define a number of extract, transform, and load (publish) services or steps to be run in a certain order, at a certain time of day, and within a certain window of time.

In accordance with an embodiment, each customer can be associated with their own activation plan(s). For example, an activation plan for a first Customer A can determine the tables to be retrieved from that customer's enterprise software application environment (e.g., their Fusion Applications environment), or determine how the services and their processes are to run in a sequence; while an activation plan for a second Customer B can likewise determine the tables to be retrieved from that customer's enterprise software application environment, or determine how the services and their processes are to run in a sequence.

As disclosed, embodiments are directed to multi-tenant development environments with isolated workspaces where the database/operating system level backup/restore mechanisms can not be exposed to the tenants, due to the need to maintain the required tenant isolation level, tenant security restrictions or other multi-tenancy related considerations. Embodiments provides a backup/restore mechanism to any number of tenants, workspaces or cloud-based applications in the multi-tenant environment with the isolated workspaces using REST API.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of backing up application data for an application in a database for a tenant in a multi-tenant cloud based system, the method comprising:
using a REST API, extracting metadata of the database that corresponds to the tenant;
based on the metadata, identifying one or more workspaces of the database that correspond to the tenant;
for each of the workspaces, calling REST API operations to collect the metadata corresponding to the workspaces and collect table data corresponding to the workspaces; and
uploading the collected metadata and table data to a backup archive.

2. The method of claim 1, wherein the one or more workspaces of the database are isolated from all other tenants using the application in the multi-tenant cloud based system.

3. The method of claim 1, wherein the application comprises an application development environment.

4. The method of claim 1, further comprising uploading the collected metadata and table data from the backup archive to an external data warehouse.

5. The method of claim 1, wherein the collected metadata and collected table data is collected in an Extensible Markup Language (XML) format.

6. The method of claim 5, further comprising creating a zipped archive of the collected metadata and collected table data.

7. The method of claim 1, wherein the application data is generated by an APEX application, and the metadata comprises CXCOMMON metadata.

8. The method claim 2, wherein all of the tenants using the application have corresponding table data stored in the database, wherein the database is shared among all of the tenants.

9. A computer readable medium having instructions stored thereon that, when executed by one or more processors, cause the processor to backup application data for an application in a database for a tenant in a multi-tenant cloud based system, the backup comprising:
using a REST API, extracting metadata of the database that corresponds to the tenant;
based on the metadata, identifying one or more workspaces of the database that correspond to the tenant;
for each of the workspaces, calling REST API operations to collect the metadata corresponding to the workspaces and collect table data corresponding to the workspaces; and
uploading the collected metadata and table data to a backup archive.

10. The computer readable medium of claim 9, wherein the one or more workspaces of the database are isolated from all other tenants using the application in the multi-tenant cloud based system.

11. The computer readable medium of claim 9, wherein the application comprises an application development environment.

12. The computer readable medium of claim 9, the backup further comprising uploading the collected metadata and table data from the backup archive to an external data warehouse.

13. The computer readable medium of claim 9, wherein the collected metadata and collected table data is collected in an Extensible Markup Language (XML) format.

14. The computer readable medium of claim 13, the backup further comprising creating a zipped archive of the collected metadata and collected table data.

15. The computer readable medium of claim 9, wherein the application data is generated by an APEX application, and the metadata comprises CXCOMMON metadata.

16. The computer readable medium of claim 10, wherein all of the tenants using the application have corresponding table data stored in the database, wherein the database is shared among all of the tenants.

17. A multi-tenant cloud based system comprising:
a database shared by a plurality of tenants when using an application;
a backup archive; and
one or more processors adapted to backing up application data for each of the plurality of tenants, the backing up comprising:
using a REST API, extract metadata of the database that corresponds to the tenant;
based on the metadata, identifying one or more workspaces of the database that correspond to the tenant;
for each of the workspaces, calling REST API operations to collect the metadata corresponding to the workspaces and collect table data corresponding to the workspaces; and
uploading the collected metadata and table data to the backup archive.

18. The system of claim 17, wherein the one or more workspaces of the database are isolated from all other tenants using the application in the multi-tenant cloud based system.

19. The system of claim 17, wherein the application comprises an application development environment.

20. The system of claim 17, the backing up further comprising uploading the collected metadata and table data from the backup archive to an external data warehouse.
